(19) United States
(12) Patent Application Publication
(10) Pub. No.: US 2007/0188415 A1
(43) Pub. Date: Aug. 16, 2007

(54) Apparatus for driving plasma display panel and plasma display

(75) Inventor: Manabu Inoue, Uji-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/354,995

(22) Filed: Feb. 16, 2006

(51) Int. Cl. G09G 3/28

(52) U.S. Cl. 345/68

(57) ABSTRACT

A PDP driving apparatus drives a plasma display panel (PDP) having sustain electrodes, scan electrodes, and address electrodes. The PDP driving apparatus has a plurality of switch elements. At least one of the plurality of switch elements is a normally-on switch element which turns on while a driving voltage is not applied to itself.

### BACKGROUND OF THE INVENTION

1. Field of the Invention

The invention relates to a driving apparatus of a plasma display panel.

2. Related Art

Plasma display is a display device making use of light emitting phenomenon by gas discharge. The display portion of the plasma display, that is, a plasma display panel (hereinafter called PDP) is more advantageous than other display devices in the aspect of large screen, thin panel, and wide viewing angle. PDP is roughly classified into DC type operated by direct-current pulses, and AC type operated by alternating-current pulses. The AC type PDP is particularly high in luminance, and simple in structure. Therefore, the AC type PDP is suited to mass production and finer pixel size, and is used in a wide range.

An AC type PDP has, for example, a three-electrode surface discharge structure (see, for example JP2003-15600, A). In this structure, address electrodes are disposed on a back surface of PDP in longitudinal direction of the panel, and sustain electrodes and scan electrodes are disposed on a front surface of the PDP alternately in lateral direction of the panel. The address electrode and scan electrode can be generally controlled for the potential individually one by one.

At the intersection of a pair of mutually adjacent sustain electrode and scan electrode and the address electrode, a discharge cell is formed. On the surface of the discharge cell, a layer made of dielectric (dielectric layer), a layer for protecting electrode and dielectric layer (protective layer), and a layer including phosphor (phosphor layer) are provided. The inside of the discharge cell is filled with gas. When discharge occurs in the discharge cell by application of a pulse voltage to the sustain electrode, scan electrode and address electrode, molecules of the gas are ionized to emit ultraviolet rays. The ultraviolet rays excite the phosphor on the discharge cell surface to generate fluorescence. As a result, the discharge cell emits light.

A PDP driving apparatus generally controls potentials of sustain electrode, scan electrode and address electrode of the PDP according to ADS (address display-period separation) method. The ADS method is one of sub-field methods. In the sub-field method, one field of image is divided into plural sub-fields. A sub-field includes a reset period, an address period, and a sustain period. In the ADS method, in particular, these three periods are set commonly in all discharge cells of the PDP (see, for example, JP2003-15600, A).

In the reset period, a reset pulse voltage is applied between the sustain electrode and scan electrode. As a result, wall charge is made uniform in all discharge cells.

In the address period, a scan pulse voltage is sequentially applied to the scan electrode, and a signal pulse voltage is applied to some of the address electrodes. Herein, the address electrodes to which the signal pulse voltage is applied are selected on the basis of a video signal entered from outside. When a scan pulse voltage is applied to one scan electrode and signal pulse voltage is applied to one address electrode, discharge occurs in the discharge cell positioned at the intersection of such scan electrode and address electrode. By this discharge, the wall charge is accumulated on the discharge cell surface.

In the sustain period, a sustain pulse voltage is applied to all pairs of sustain electrode and scan electrode simultaneously and periodically. At this time, in the discharge cell in which the wall charge is accumulated in the address period, discharge by gas continues and luminance occurs. Duration of the sustain period varies in each sub-field, and the light emitting time per field of discharge cell, that is, the luminance of discharge cell is adjusted by selection of sub-field to be emitted.

FIG. 9 is a block diagram of a scan electrode driving section of a conventional PDP driving apparatus. The scan electrode driving section 110 includes a scan pulse generating section 111, a reset pulse generating section 112, and a sustain pulse generating section 113. The PDP 20 is expressed by an equivalent circuit of floating capacity Cp (panel capacity of PDP) between the sustain electrode X and the scan electrode Y.

The scan pulse generating section 111 has a first constant voltage source V1, a high side scan switch element Q1Y, and a low side scan switch element Q2Y. The reset pulse generating section 112 has a second constant voltage source V2, a high side ramp waveform generating section QR1, a low side ramp waveform generating section QR2, and a separate switch element QS. The sustain pulse generating section 113 has a high side sustain switch element Q7Y, a low side sustain switch element Q8Y, a first recovery diode D1, a second recovery diode D2, a high side recovery switch element Q9Y, a low side recovery switch element Q10Y, a recovery capacitor CY, and a recovery inductor LY.

Thus, the PDP driving apparatus includes various switch elements, and the switch elements are turned on and off, so that specified voltages are applied to the electrodes of the PDP.

There are two types of switch elements, that is, “normally-on switch element” and “normally-off switch element”. A normally-on switch element is a switch element which turns on when a voltage between gate and source is zero, and a normally-off switch element is a switch element which turns off when a voltage between gate and source is zero. The normally-on switch element includes, for example, MOSFET, IGBT, bipolar transistor, JFET (junction type field effect transistor), and MESFET (metal semiconductor field effect transistor, see reference *1). Characteristics (resistance value, switching speed, and others) of switch element are better in normally-on switch element than in normally-off switch element. Further, to enhance the characteristics of switch element, a wide gap semiconductor is effective. A wide gap semiconductor means a semiconductor which has higher band gap than Si. The wide band gap semiconductor includes, for example, silicon carbide (SiC), diamond, gallium nitride (GaN), or zinc oxide (ZnO). Besides, as normally-on switch element, materials having similar characteristics may be used. Since the wide band gap semiconductor has small ON resistance, it has, advantage in power loss. However, the normally-off switch element is generally preferred owing to the following reasons.

*1) Reference: M. Hikita, M. Yanagihara, K. Nakazawa, H. Uen, Y. Hirose, T. Ueda, Y. Uemoto, T. Tanaka, D. Ueda, and T. Egawa, “350V/150A AlGaN/GaN power HFET on Silicon substrate with source-via grounding (SVG) structure”, in IEDM Tech. Dig., 803-806 (2004).

For example, in case of employing a normally-on switch element as a sustain switch element, when supply of external alternating-current power source is stopped due to lightning strike or other accident, the gate voltage of the sustain switch element becomes zero. When the gate voltage of the sustain switch element becomes zero, the sustain switch elements maintains the ON state because it is a normally-on switch element. That is, the high side sustain switch element and low side sustain switch element maintain the ON state simultaneously, and are simultaneously short-circuited, and a large current flows from a sustain voltage source Vs through two sustain switch elements, and thereby the circuit may be broken down.

Besides, in the separate switch element and two sustain switch elements of the PDP driving apparatus, a current due to application of the sustain pulse voltage (current due to discharge in discharge cell of PDP) is flowing during a sustain period.

In the recovery switch element, separate switch element and sustain switch elements, a current due to recovery action is flowing during the sustain period. Sine this current amount is generally larger than the current due to application of other pulse voltage (the peak value is more than hundreds of Ampere), in order to save power consumption in the PDP driving apparatus, it is important to lower the conduction loss in the separate switch element, sustain switch elements, and recovery switch element. Therefore, regarding separate switch element, sustain switch element, and recovery switch element, plurality of switches are used which are connected in parallel, and thus the mounting area of these switch elements is increased. It is hence difficult to satisfy saving of power consumption and reduction in the number of electronic parts at the same time.

### SUMMARY OF THE INVENTION

The invention is devised to solve the problems, and it is hence an object thereof to present a PDP driving apparatus which uses as switch element a normally-on type having excellent characteristics, and is capable of stopping safely the PDP driving apparatus without destroying the circuit in the event of sudden power down of a commercial alternating-current power supply. It is a further object of the invention to present a PDP driving apparatus capable of satisfying saving of power consumption, and reduction in the number of electronic parts at the same time.

A first aspect of the invention provides a PDP driving apparatus for driving a plasma display panel that has sustain electrodes, scan electrodes, and address electrodes. The PDP driving apparatus includes a plurality of switch elements. At least one of the plurality of switch elements is a normally-on switch element which turns on while a driving voltage is not applied to itself.

A second aspect of the invention provides a plasma display panel having sustain electrodes, scan electrodes, and address electrodes, and a plasma display panel having the PDP driving apparatus for driving the plasma display panel.

### EFFECTS OF THE INVENTION

According to the invention, for switch elements of the PDP driving apparatus, a normally-on switch element with better characteristics can be used. Hence even if supply of commercial alternating-current power source is suddenly stopped, simultaneous conduction of switch elements disposed at high voltage side and low voltage side can be prevented, and the operation can be stopped safely without destroying the circuit, thereby resulting in enhancement of the reliability of PDP driving apparatus.

Further, using the normally-on switch element which is composed of a wide band gap semiconductor, both saving of power consumption and reduction in the number of electronic parts can be satisfied at the same time. As a result, the PDP driving apparatus is further reduced in size, the mounting surface area is saved, and the wiring impedance is lowered. The invention can further decrease largely the conduction loss in separate switch element, recovery switch element, and sustain switch element during the sustain period, thereby reducing power consumption.

### BRIEF DESCRIPTION OF DRAWINGS

FIG. 1 is a block diagram of a structure of a plasma display in embodiment 1 of the invention.

FIG. 2 is a diagram showing a detail configuration of a scan electrode driving section in embodiment 1 of the invention.

FIG. 3 is a waveform diagram of an applied voltage to scan electrodes of PDP, and ON periods of switch elements included in the scan electrode driving section, during a reset period, an address period, and a discharge sustain period in embodiment 1 of the invention.

FIG. 4 is a diagram showing a configuration of a power source circuit for generating a driving voltage of a switch element in embodiment 1 of the invention.

FIG. 5 is a diagram showing a configuration of a gate driving circuit of a high side sustain switch element in embodiment 1 of the invention.

FIG. 6 is a diagram showing a detail configuration of a scan electrode driving section in embodiment 2 of the invention.

FIG. 7 is a diagram showing a gate driving circuit of a high side sustain switch element in embodiment 2 of the invention.

FIG. 8 is a diagram showing a configuration of a power source circuit for generating a driving voltage of a switch element in embodiment 3 of the invention.

FIG. 9 is a diagram showing a configuration of a scan electrode driving section of a conventional PDP driving apparatus.

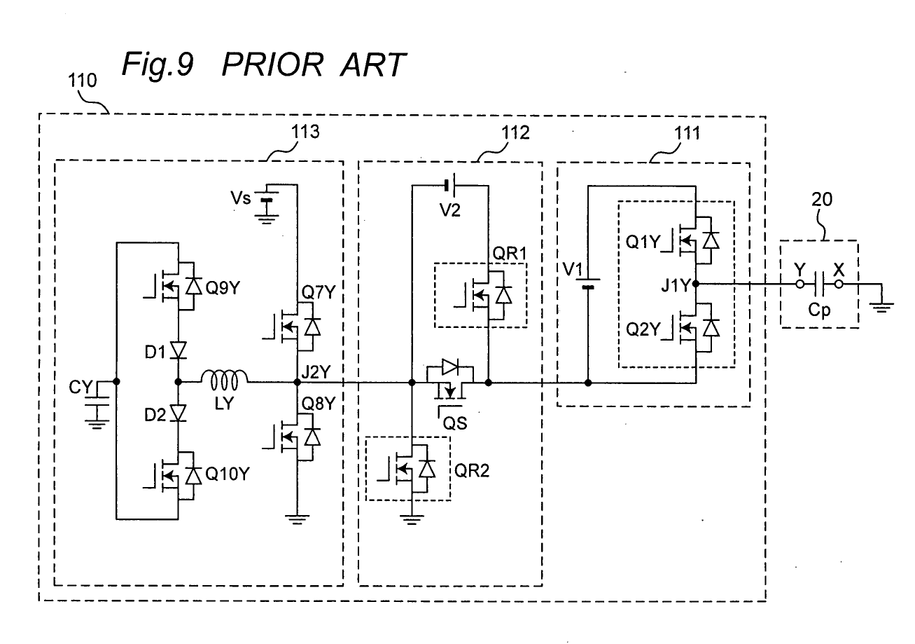

### DETAIL DESCRIPTION OF PREFERRED EMBODIMENT

Referring now to the drawings, preferred embodiments of the invention are described below.

### Embodiment 1

1.1 Configuration

1.1.1 Plasma Display

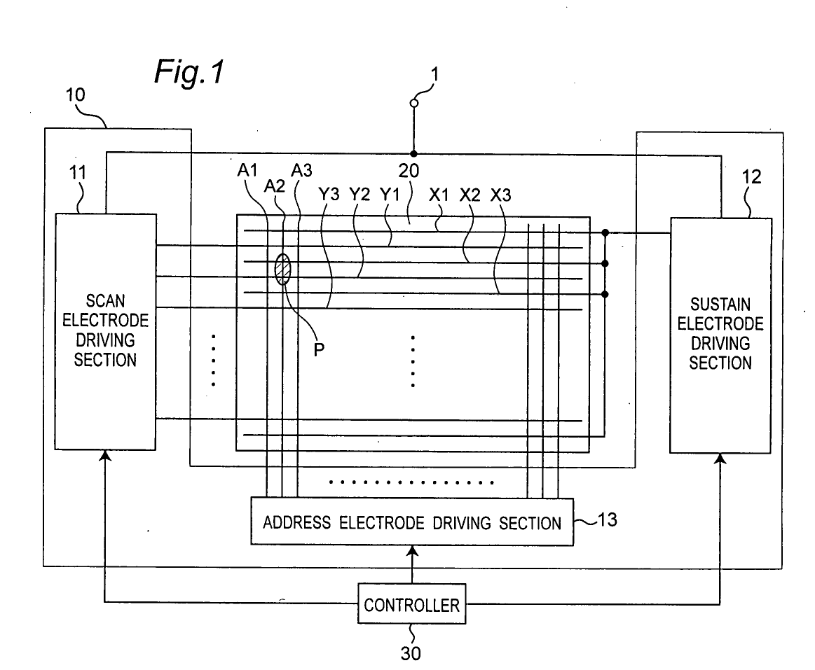

FIG. 1 is a block diagram showing a configuration of a plasma display in an embodiment of the invention. The plasma display includes a PDP driving apparatus 10, a plasma display panel (PDP) 20, and a controller 30.

(Plasma Display Panel)

The PDP 20 is, for example, of AC type, having three-electrode surface discharge type structure. On a back surface of the PDP 20, address electrodes A1, A2, A3, . . . are disposed along the width direction of the panel. On a front surface of the PDP 20, sustain electrodes X1, X2, X3, . . . and scan electrodes Y1, Y2, Y3, . . . are disposed alternately along the longitudinal direction of the panel. The sustain electrodes X1, X2, X3, . . . are mutually coupled to have substantially equal potential. The address electrodes A1, A2, A3, . . . , and scan electrodes Y1, Y2, Y3, . . . can be controlled individually for the potential.

A discharge cell is disposed at an intersection (for example, shaded area P in FIG. 1) of a pair of mutually adjacent sustain electrode and scan electrode (for example, a pair of sustain electrode X2 and scan electrode Y2) and an address electrode (for example, address electrode A2). The surface of the discharge cell includes a layer (dielectric layer) made of dielectric, a layer (protective layer) for protecting the electrodes and dielectric layer, and a layer (phosphor layer) including phosphor. The inside of the discharge cell is filled with gas. Application of a specified voltage to the sustain electrode, scan electrode, and address electrode causes discharge in the discharge cell. At this time, gas molecules in the discharge cell are ionized to emit ultraviolet rays. The ultraviolet rays excite the phosphor on the discharge cell surface to generate fluorescence. As a result, the discharge cell emits light.

(PDP Driving Apparatus)

The PDP driving apparatus 10 includes a scan electrode driving section 11, a sustain electrode driving section 12, and an address electrode driving section 13.

An input terminal 1 of the scan electrode driving section 11 and the sustain electrode driving section 12 is connected to a power supply unit (not shown). The power supply unit first converts an alternating-current voltage from an external commercial power source to a specific direct-current voltage (for example, 400V). The direct-current voltage is further converted into a specified direct-current voltage (hereinafter called “sustain voltage”) Vs by a DC-DC converter. The sustain voltage Vs is applied to the PDP driving apparatus 10. As a result, the potential at the input terminal 1 is maintained higher than a ground potential (about zero) by a sustain voltage Vs.

Output terminals of the scan electrode driving section 11 are individually connected to scan electrodes Y1, Y2, Y3, . . . of the PDP 20. The scan electrode driving section 11 changes each potential of scan electrodes Y1, Y2, Y3, . . . , individually.

Output terminals of the sustain electrode driving section 12 are individually connected to sustain electrodes X1, X2, X3, . . . of the PDP 20. The sustain electrode driving section 12 changes uniformly potentials of sustain electrodes X1, X2, X3, . . . .

The address electrode driving section 13 is connected to address electrodes A1, A2, A3, . . . of the PDP 20, individually. The address electrode driving section 13 generates a signal pulse voltage on the basis of a video signal from outside, and applies it to electrodes selected from address electrodes A1, A2, A3, . . . .

The PDP driving apparatus 10 controls the potential of each electrode of the PDP 20 according to the ADS (Address Display-period Separation) method. The ADS is one of sub-field methods. For example, in television broadcast in Japan, one field of image is sent at intervals of 1/60 second (about 16.7 msec). Therefore, the display time per field is constant. In the sub-field method, one field is divided into plural sub-fields. According to ADS method, in each sub-field, three periods (reset period, address period, and sustain period) are set commonly for all discharge cells of the PDP 20. Duration of the sustain period differs in each sub-field. In the reset period, address period, and sustain period, different pulse voltages are applied to discharge cells as follows.

In the reset period, a reset pulse voltage is applied between the sustain electrodes X1, X2, X3, . . . and scan electrodes Y1, Y2, Y3, . . . . As a result, the wall charge is made uniform in all discharge cells.

In the address period, the scan electrode driving section 11 applies a scan pulse voltage sequentially to the scan electrodes Y1, Y2, Y3, . . . . Simultaneously with application of the scan pulse voltage, the address electrode driving section 13 applies a signal pulse voltage to the address electrodes A1, A2, A3, . . . . Herein, the address electrodes to be applied with the signal pulse voltage are selected on the basis of a video signal entered from outside. Application of a scan pulse voltage to one scan electrode and a signal pulse voltage to one address electrode causes discharge in the discharge cell positioned at the intersection of the scan electrode and address electrode. This discharge causes a wall charge to be accumulated on the discharge cell surface.

In the sustain period, the scan electrode driving section 11 and sustain electrode driving section 12 alternately apply sustain pulse voltages to scan electrodes Y1, Y2, Y3, . . . or sustain electrodes X1, X2, X3, . . . . At this time, the discharge is sustained at the discharge cells in which wall charge is accumulated during the address period. Since duration of the sustain period varies in each sub-field, the light emitting time of the discharge cell per field, that is, the luminance of the discharge cell is adjusted by selection of sub-fields to be emitted.

The scan electrode driving section 11, sustain electrode driving section 12, and address electrode driving section 13 individually incorporate switching inverters inside. The controller 30 controls switching of these driving sections. As a result, the reset pulse voltage, scan pulse voltage, signal pulse voltage, and sustain pulse voltage are generated in specified waveform and at specified timing, individually. The controller 30, in particular, selects address electrodes to be applied with signal pulse voltages based on a video signal from outside. Further, the controller 30 determines the duration of the sustain period after application of the signal pulse voltage, that is, the sub-field to which the signal pulse voltage is to be applied. As a result, each discharge cell emits with appropriate luminance. Thus, the video image corresponding to the video signal is reproduced on the PDP 20.

1.1.2 Scan Electrode Driving Section

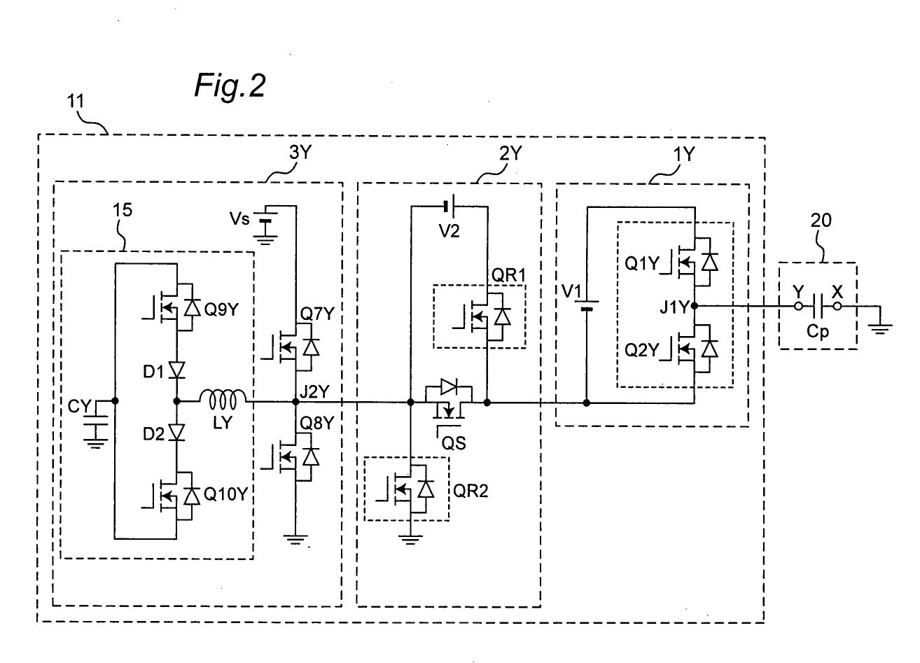

FIG. 2 specifically shows a configuration of the scan electrode driving section 11. FIG. 2 also shows an equivalent circuit of the PDP 20. The scan electrode driving section 11 includes a scan pulse generating section 1Y, a reset pulse generating section 2Y, and a sustain pulse generating section 3Y. The PDP 20 is equivalently expressed as a floating capacity Cp (PDP panel capacity) between the sustain electrode X and scan electrode Y. A path of a current which flows in the PDP 20 on discharge of the discharge cell is not shown. In FIG. 2, the sustain electrode driving section connected to the sustain electrode X is omitted, and the sustain electrode X is shown in grounded state in the diagram.

(Scan Pulse Generating Section)

The scan pulse generating section 1Y includes a first constant voltage source V1, a high side scan switch element Q1Y, and low side scan switch element Q1Y. The first constant voltage source V1 maintains the potential of the positive electrode higher than the potential of the negative electrode by a specific voltage V1, on the basis of the sustain voltage Vs applied from the power source unit, by, for example, a DC-DC converter (not shown).

The two scan switch elements Q1Y and Q2Y are, for example, MOSFETs. They may be also IGBTs or bipolar transistors.

The positive electrode of the first constant voltage source V1 is connected to the drain of the high side scan switch element Q1Y. The source of the high side scan switch element Q1Y is connected to the drain of the low side scan switch element Q2Y. The junction J1Y of them is connected to one of scanning electrode Y of the PDP 20. The source of the low side scan switch element Q2Y is connected to the negative electrode of the first constant voltage source V1.

Herein, the series connection circuits (portion enclosed by solid line in FIG. 2) of the high side scan switch element Q1Y and low side scan switch element Q2Y are actually provided as many as the number of scan electrodes Y1, Y2, . . . , and are individually connected to the scan electrodes Y1, Y2, . . . .

(Reset Pulse Generating Section)

The reset pulse generating section 2Y includes a second constant voltage source V2, a high side lamp waveform generating section QR1, a low side lamp waveform generating section QR2, and a separate switch element QS.

The second constant voltage source V2 maintains the potential of its positive electrode higher than the potential of the negative electrode by a specific voltage V2, on the basis of the sustain voltage Vs applied from the power source unit, by, for example, a DC-DC converter (not shown).

The ramp waveform generating sections QR1 and QR2 include, for example, N channel MOSFETs (NMOS). The gate and drain of NMOS are connected by way of a capacitor (not shown). When the ramp waveform generating sections QR1 and QR2 are turned on, a voltage between drain and source is substantially changed to zero at a specific speed.

The separate switch element QS is, for example, a MOSFET.

The positive electrode of the second constant voltage source V2 is connected to the drain of the high side ramp waveform generating section QR1. The source of the high side ramp waveform generating section QR1 is connected to the drain of the separate switch element QS, and is also connected to the negative electrode of the first constant voltage source V1. The negative electrode of the second constant voltage source V2 is connected to the source of the separate switch element QS. The drain of the low side ramp waveform generating section QR2 is connected to the source of the separate switch element QS, and is also connected to the negative electrode of the second constant voltage source V2. The source of the low side ramp waveform generating section QR2 is grounded.

(Sustain Pulse Generating Section)

The sustain pulse generating section 3Y has a high side sustain switch element Q7Y, a low side sustain switch element Q8Y, and a recovery switch circuit 15. The recovery switch circuit 15 includes a first recovery diode D1, a second recovery diode D2, a high side recovery switch element Q9Y, a low side recovery switch element Q10Y, a recovery capacitor CY and a recovery inductor LY.

(Sustain Switch Element Composed of Normally-On Switch Element)

Two sustain switch elements Q7Y and Q8Y, and two recovery switches Q9Y and Q10Y are, for example, MOSFETs. They may be also composed of IGBT or bipolar transistors.

In particular, either one of two sustain switch elements Q7Y and Q8Y is composed of a normally-on switch element, and the other is composed of a normally-off switch element.

A normally-on switch element is a switch element which turns on when a voltage between gate and source is zero, and a normally-off switch element is a switch element which turns off when a voltage between gate and source is zero. For example, the normally-on switch element includes MOSFET, IGBT, bipolar transistor, JFET (junction type field effect transistor), and MESFET (metal semiconductor field effect transistor, see reference *1). Characteristics (resistance value, switching speed, and others) of switch element are better in normally-on switch element than in normally-off switch element.

In the embodiment a wide gap semiconductor is used as normally-on switch element, which is a semiconductor having higher band gap than Si. The wide band gap semiconductor includes, for example, silicon carbide (SiC), diamond, gallium nitride (GaN), or zinc oxide (ZnO). Besides, as normally-on switch element, materials having similar characteristics may be used. Using wide band gap semiconductor, lower resistance value and higher switching speed may be realized even in a switch element having high rating voltage. Using the semiconductor as switching element, both saving of power consumption and reduction in the number of parts are satisfied at the same time.

In this embodiment, the low side sustain switch element Q8Y is a normally-on switch element, and the high side sustain switch element Q7Y is a normally-off switch element. That is, the low side sustain switch element Q8Y turns on when a voltage between the gate and source is zero, and turns off when the gate-source voltage is a specified voltage (−VG1). The high side sustain switch element Q7Y turns off when a voltage between the gate and source is zero, and turns on when the gate-source voltage is specified voltage (VG2).

The sustain voltage source Vs maintains the potential of its positive electrode higher than the potential of the negative electrode by a specific voltage Vs (sustain voltage). The positive electrode of the sustain voltage source Vs is connected to the drain of the high side sustain switch element Q7Y, and the source of the high side sustain switch element Q7Y is connected to the drain of the low side sustain switch element Q8Y. The source of the low side sustain switch element Q8Y is connected to the negative electrode of the sustain voltage source Vs. The negative electrode of the sustain voltage source Vs is, for example, 0 V (grounded state). Junction J2Y of the high side sustain switch element Q7Y and the low side sustain switch element Q8Y is connected to the source of the separate switch element QS, as output terminal of the sustain pulse generating section 3Y. The path from the output terminal J2Y of the sustain pulse generating section 3Y to the source of the low side scan switch element Q2Y by way of separate switch element QS is called “sustain pulse transmission path”.

(Recovery Switch Circuit)

Two recovery switch elements Q9Y and Q10Y are, for example, MOSFET, IGBT or bipolar transistors. The source of the high side recovery switch element Q9Y is connected to the anode of the first recovery diode D1, the cathode of the first recovery diode D1 is connected to the anode of the second recovery diode D2, and the cathode of the second recovery diode D2 is connected to the drain of the low side recovery switch element Q10Y. One end of the recovery inductor LY is connected to the junction J2Y, and the other end is connected to the cathode of the first recovery diode D1. One end of the recovery capacitor CY is connected to the negative electrode of the sustain voltage source Vs, and the other end is connected to the drain of the high side recovery switch element Q9Y and the source of the low side recovery switch element Q10Y.

The capacity of the recovery capacitor CY is sufficiently larger than the panel capacity Cp of the PDP 20. The voltage across the recovery capacitor CY is maintained substantially same as a half (Vs/2) of the sustain voltage Vs applied from the power supply unit.

1.2 Operation

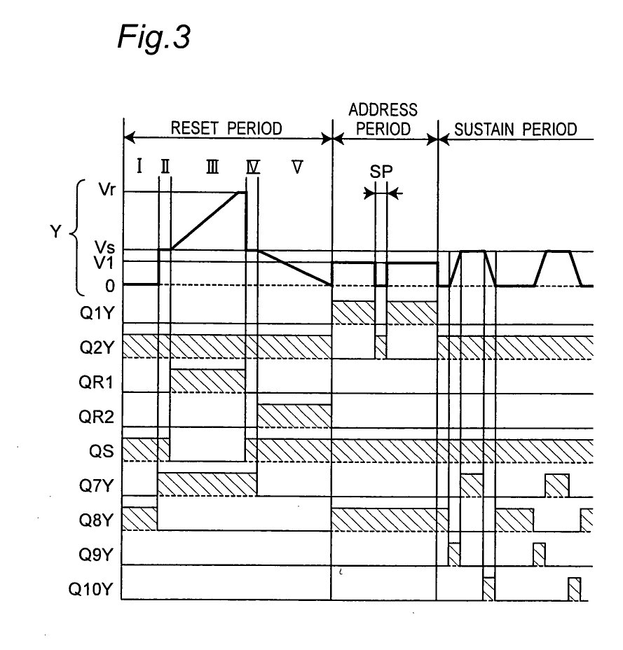

FIG. 3 is a waveform diagram of the applied voltage to scan electrodes of PDP 20, and ON periods of switch elements Q1Y, Q2Y, QR1, QR2, QS, and Q7Y to Q10Y included in the scan electrode driving section 11, during the reset period, the address period, and the discharge sustain period. In FIG. 3, the ON period of each switch element is indicated in the shaded area.

1.2.1 Reset Period

Depending on changes of a reset pulse voltage, the reset period is divided into the following five modes I to V.

<Mode I>

In the scan electrode driving section 11, the separate switch element QS, the low side scan switch element Q2Y and low side sustain switch element Q8Y are maintained in ON state (The other switch elements are maintained in OFF state.). As a result, the scan electrode Y is maintained at the ground potential (about zero).

<Mode II>

In the scan electrode driving section 11, while the separate switch QS and the low side scan switch element Q2Y are kept in ON state, the low side sustain switch element Q8Y is turned off, and the high side sustain switch Q7Y is turned on (The other switch elements are held in OFF state). As a result, the potential of the scan electrode Y is raised to a potential Vs higher than the grounding potential (about 0) by the sustain voltage Vs.

<Mode III>

In the scan electrode driving section 11, while the low side scan switch element Q2Y and the high side sustain switch element Q7Y are kept in ON state, the separate switch element QS is turned off, and the high side ramp waveform generating section QR1 is turned on (the other switch elements are held in OFF state). As a result, the potential of the scan electrode Y is raised at a specific speed to a potential Vr (hereinafter called “upper limit of the reset pulse voltage”) higher than the grounding potential (about 0) by the sum of the sustain voltage Vs and the voltage V2.

Thus, for all discharge cells of the PDP 20, the applied voltage is uniformly elevated relatively slowly to the upper limit Vr of the reset pulse voltage. As a result, a uniform wall charge is accumulated in all discharge cells of the PDP 20. At this time, since the elevation speed of the applied voltage is small, luminance of the discharge cell is suppressed very low.

<Mode IV>

In the scan electrode driving section 11, while the low side scan switch element Q2Y and the high side sustain switch element Q7Y are kept in ON state, the high side ramp waveform generating section QR1 is turned off, and the separate switch element QS is turned on (the other switch elements are held in OFF state). As a result, the potential of the scan electrode Y is lowered to a potential higher than the grounding potential (about 0) by the voltage Vs.

<Mode V>

In the scan electrode driving section 11, while the low side scan switch element Q2Y and the separate switch element QS are kept in ON state, the high side sustain switch element Q7Y is turned off, and the low side ramp waveform generating section QR2 is turned on (the other switch elements are held in OFF state). As a result, the potential of the scan electrode Y is lowered from Vs to the grounding potential (about 0) at specific speed. Therefore, in the discharge cell of the PDP 20, a voltage with reverse polarity of the applied voltage during modes II to IV is applied. In particular, the applied voltage descends slowly. Hence, in all discharge cells the wall charge is removed equally to be made uniform. At this time, since the descending speed of the applied voltage is small, light emission of the discharge cell is suppressed low.

1.2.2 Address Period

During the address period, in the scan electrode driving section 11, the separate switch element QS and the low side sustain switch element Q8Y are maintained in ON state. Therefore, the drain of the high side scan switch element Q1Y is maintained at a potential V1 (hereinafter called “upper limit of the scan pulse voltage”) higher than the grounding potential by the voltage V1, and the source of the low side scan switch Q2Y is maintained at the grounding potential.

Upon start of the address period, for all scan electrodes Y, the high side scan switch element Q1Y is maintained in ON state, and the low side scan switch element Q2Y is maintained in OFF state. As a result, the potential of all scan electrodes Y is uniformly maintained at the upper limit V1 of the scan pulse voltage.

Successively, the scan electrode driving section 11 changes the potential of the scan electrode Y as follows (see the scan pulse voltage SP shown in FIG. 3). When one scan electrode Y is selected, the high side scan switch element Q1Y which is connected to the selected scan electrode Y is turned off, and the low side scan switch element Q2Y which is connected to the selected scan electrode Y is turned on. As a result, the potential of this scan electrode Y is lowered to the grounding potential. When the potential of this scan electrode Y is maintained at the grounding potential for a specified time, the low side scan switch element Q2Y connected to the selected scan electrode Y is turned off, and the high side scan switch element Q1Y connected to the selected scan electrode Y is turned on. Consequently, the potential of the scan electrode Y is elevated up to the upper limit V1 of the scan pulse voltage. Similarly the scan electrode driving section 11 switches sequentially scan switch elements Q1Y and Q2Y connected to each of the scan electrodes. Thus, the scan pulse voltage SP is sequentially applied to each scan electrode.

During the address period, one of address electrodes A is selected on the basis of the video signal entered from outside, and the potential of the selected address electrode A is elevated to the upper limit Va of the signal pulse voltage for a specified time (not shown).

For example, when the scan pulse voltage SP is applied to one scan electrode Y and the signal pulse voltage is applied to one address electrode A, a voltage between the scan electrode Y and the address electrode A is higher than a voltage between other electrodes. Therefore, discharge occurs in the discharge cell positioned at the intersection of this scan electrode Y and this address electrode A. This discharge causes a new wall charge to be accumulated on the discharge cell surface.

During the sustain period, the scan electrode driving section 11 and the sustain electrode driving section 12 (not shown) alternately apply sustain pulse voltages to the scan electrode Y and sustain electrode X (see FIG. 3). At this time, discharge continues in the discharge cell in which the wall charge is accumulated during the address period, and hence light is emitted.

1.2.3 Sustain Period

The sustain period is explained below. During the sustain period, the separate switch element QS and the low side scan switch element Q2Y are always maintained in ON state.

Immediately before the high side recovery switch element Q9Y is turned on, the low side sustain switch element Q8Y is ON, and a voltage across the panel capacity Cp is maintained at 0V. When the high side recovery switch element Q9Y is turned on, an LC resonance circuit is formed by the recovery capacitor CY, the high side recovery switch Q9Y, the first recovery diode D1, the recovery inductor LY, and the panel capacity Cp, and the voltage across the panel capacity Cp elevates up to Vs (The other switch elements are kept in OFF state.).

Then, when the high side recovery switch element Q9Y is turned off and the high side sustain switch element Q7Y is turned on, a voltage across the panel capacity Cp is maintained at Vs. At this time, a voltage between the drain and the source of the high side sustain switch element Q7Y is zero, thus resulting in turn-on of switch with almost no loss (The other switch elements are maintained in OFF state.).

After a specified time, the high side sustain switch element Q7Y is turned off, and the low side recovery switch element Q10Y is turned on, and then an LC resonance circuit is formed by the recovery capacitor CY, the low side recovery switch element Q10Y, the second recovery diode D2, the recovery inductor LY and the panel capacity Cp, and the voltage across the panel capacity Cp is decreased to 0 (The other switch elements are kept in OFF state.).

Afterward, when the low side recovery switch element Q10Y is turned off and the low side sustain switch element Q8Y is turned on, the voltage across the panel capacity Cp is maintained at 0V. At this time, since the voltage between the drain and the source of the low side sustain switch element Q8Y is zero, and thus achieving turn-on with loss of almost zero (The other switch elements are maintained in OFF state.).

When the potential of the scan electrode Y rises or falls, electric power is efficiently exchanged between the recovery capacitor CY and the panel capacity Cp. Thus, when the sustain pulse voltage is applied, reactive power due to charge or discharge of the panel capacity is decreased.

1.3 Power Source Circuit

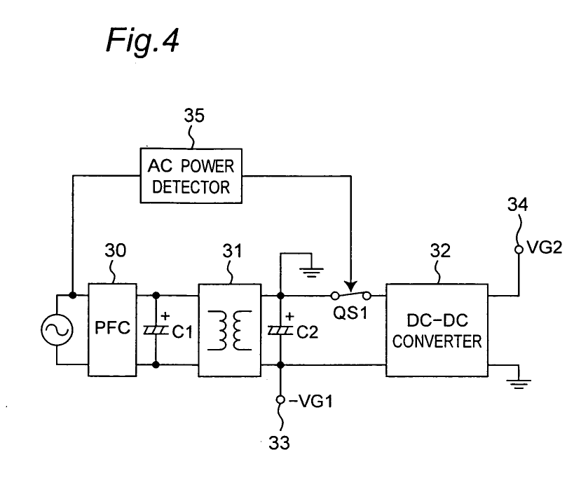

FIG. 4 shows the power source circuit in embodiment 1 of the invention. The power source circuit generates and supplies a driving voltage for driving sustain switch elements Q7Y and Q8Y. A power source circuit for supplying a driving voltage to the high side recovery switch element Q9Y, the low side recovery switch element Q10Y, or the separate switch element QS has the same configuration as shown in FIG. 4, of which explanation is omitted.

The power source circuit includes a power factor correction circuit 30, a first DC-DC converter 31, a second DC-DC converter 32, a first input capacitor C1, a second input capacitor C2, a first cut off switch QS1, and an alternating-current (AC) power detector 35.

The power factor correction circuit 30 converts the alternating-current voltage from an external commercial alternating-current power source into a specific direct-current voltage (for example, 400 V). The power factor correction circuit 30 operates such that the power factor of the AC voltage as input voltage and the AC current as input current is substantially 1.

The first DC-DC converter 31 operates using the voltage of the first input capacitor C1 as input voltage. The first input capacitor C1 receives an output voltage (for example, 400 V) of the power factor correction circuit 30. The first DC-DC converter 31 is an isolated DC-DC converter using a transformer and converts the input voltage into a first gate voltage VG1.

The first gate voltage VG1 maintains the potential of the positive electrode higher than the potential of the negative electrode by the specific voltage VG1. The gate voltage VG1 is a voltage necessary for driving the gate of switch element such as MOSFET or IGBT (for example, 15 V). The positive pole of the first gate voltage VG1 is at the grounding potential, and the negative pole of the first gate voltage VG1 is connected to the first power output terminal 33. The first power output terminal 33 outputs a voltage of −VG1 with respect to the grounding potential.

The positive electrode of the second input capacitor C2 is grounded, and its negative electrode is connected to the first power output terminal 33, and hence the voltage applied to the second input capacitor C2 is same as the first gate voltage. The second DC-DC converter 32 operates using the second input capacitor 32 as input voltage. The second DC-DC converter 32 is an inversion type DC-DC converter which inverts polarity of the input voltage and outputs the voltage with inverted polarity. The second DC-DC converter 32 converts the input voltage to the second gate voltage VG2. As inverted DC-DC converter, a non-isolated step-up/down converter, or a DC-DC converter using a transistor for inverting the output voltage may be used.

Second gate voltage VG2 maintains the potential of the positive electrode higher than the potential of the negative electrode by a specific voltage VG2. The second gate voltage VG2 is a voltage (for example, 15 V) necessary for driving the gate of switch elements such as MOSFET or IGBT. The negative pole of the second gate voltage VG2 is the grounding potential, and the positive pole of the second gate voltage VG2 is connected to a second power output terminal 34.

One end of the first cut off switch element QS1 is connected to the positive electrode of the second input capacitor C2, and the other end is connected to the second DC-DC converter 32. During ON period of the first cut off switch element QS1, since electric power is supplied to the second DC-DC converter 32 through the second input capacitor C2, the operation of the second DC-DC converter 32 can provide a converted second gate voltage VG2. During OFF period of the first cut off switch element QS1, since electric power is not supplied to the second DC-DC converter 32, the second DC-DC converter 32 does not operate and cannot provide a converted second gate voltage VG2.

The first cut off switch element QS1 is controlled to be turned on or off by alternating-current power detector 35. AC power detector 35 detects AC voltage or AC current of the external commercial alternating-current power source. When no AC voltage nor AC current is detected, a signal for turning off the first cut off switch element QS1 is output, while a signal for turning on the first cut off switch element QS1 is output when AC voltage or AC current detected.

1.4 Gate Driving Circuit for Sustain Switch Elements

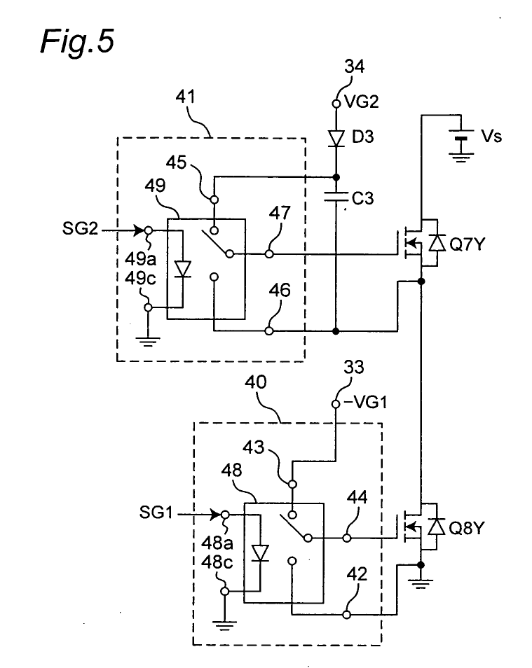

FIG. 5 is a diagram of a gate driving circuit for the high side sustain switch element Q7Y and the low side sustain switch element Q8Y in the embodiment 1 of the invention. The gate driving circuit shown in FIG. 5 receives a voltage for driving the sustain switch elements Q7Y and Q8Y from the power source circuit shown in FIG. 4 via the first and second output terminals 33 and 34.

A gate driving circuit for the high side recovery switch element Q9Y, the low side recovery switch element Q10Y, and the separate switch element QS has almost the same configuration as the gate driving circuit of the high side sustain switch element Q7Y, and its explanation is omitted.

The gate driving circuit includes a first gate signal circuit 40, a second gate signal circuit 41, a first driving capacitor C3, and a first driving diode D3.

The first gate signal circuit 40 incorporates a photo coupler 48. A signal SG1 for controlling the low side sustain switch element Q8Y from the controller 30 is connected to the anode 48a of the photo coupler 48, and its cathode 48c is grounded. In the first gate signal circuit 40, a terminal 42 for supplying a voltage for turning on a switch element is connected to the source of the low side sustain switch element Q8Y. In the first gate signal circuit 40, the terminal 43 for supplying a voltage for turning off a switch element is connected to the first power output terminal 33. The output terminal 44 of the first gate signal circuit 40 is connected to the gate of the low side sustain switch element Q8Y.

The second gate signal 41 incorporates a photo coupler 49. A signal SG2 for controlling the high side sustain switch element Q7Y from the controller 30 is connected to an anode 49a of the photo coupler 49, and a cathode 49c of the photo coupler is grounded. In the second gate signal circuit 41, a terminal 45 for supplying a voltage for turning on a switch element is connected to the positive electrode of the first driving capacitor C3, and the negative electrode of the first driving capacitor C3 is connected to the source of the high side sustain switch element Q7Y. The anode of the first driving diode D3 is connected to the output terminal 34, and the cathode of the first driving diode D3 is connected to the positive electrode of the first driving capacitor C3. An output 47 of the second gate signal circuit 41 is connected to the gate of the high side sustain switch element Q7Y. In this embodiment, the gate signal circuit incorporates a photo coupler, but the gate signal circuit may not necessarily incorporate the photo coupler. In such a case, for example, the photo coupler and gate signal circuit are provided separately.

(Operation in Normal State)

The gate driving circuit normally operates as follows.

When the control signal SG1 from the controller 30 for controlling the low side sustain switch element Q8Y becomes “H”, the first gate signal circuit 40 applies the source potential of the low side sustain switch element Q8Y to the gate of the low side sustain switch element Q8Y to turn on the low side sustain switch element Q8Y. At this time, the source potential of the high side sustain switch element Q7Y is the grounding potential, and the first driving capacitor C3 is charged by a voltage supplied from the output terminal 34 via the first driving diode D3.

When the control signal SG1 becomes “L”, the first gate signal circuit 40 applies the supply voltage (−VG1) from the first power output terminal 33 to the gate of the low side sustain switch element Q8Y to turn off the low side sustain switch element Q8Y.

On the other hand, when the control signal SG2 for controlling the high side sustain switch element Q7Y becomes “H”, the second gate signal circuit 41 applies a voltage charged in the first driving capacitor C3 to the gate of the high side sustain switch element Q7Y to turn on the high side sustain switch element Q7Y. At this time, the source potential of the high side sustain switch element Q7Y becomes a voltage of the sustain voltage source Vs, and therefore the first driving capacitor C3 is not charged with the supply voltage from the second power output terminal 34 by the first driving diode D3.

When the control signal SG2 becomes “L”, the second gate signal circuit 41 connects the gate of the high side sustain switch element Q7Y to its source to turn off the high side sustain switch element Q7Y. Thus, the gate driving circuit amplifies signals SG1 and SG2 and applies them to the gates of two sustain switch elements Q7Y and Q8Y, thereby driving the two sustain switch elements Q7Y and Q8Y.

(Operation During Power Down Due to Fault)

In the event of power down of external commercial alternating-current power source due to lighting strike or other failure, the operation is as follows.

In the power source circuit shown in FIG. 4, when detecting stop of supplying alternating-current voltage, the AC power detector 35 immediately turns off the first cut off switch element QS1. As a result, the supply of the power from the second input capacitor C2 is stopped, and the second DC-DC converter 32 immediately stops the operation, causing the output of the second gate voltage VG2 to be stopped. Consequently, the power supplied to the first driving capacitor C3 is also stopped. Therefore, even if the control signal SG2 from the controller 30 is “H”, the positive terminal of the first driving capacitor C3 of the second gate signal circuit 41 is almost same potential as the source potential of the high side sustain switch element Q7Y, and therefore the high side sustain switch element Q7Y which is a normally-off switch element does not turn on. Thus, the high side sustain switch element Q7Y can be turned off in a short time.

At this time, in the low side sustain switch element Q8Y, although the AC voltage is stopped, the first input capacitor C1 is still in charged state and the first DC-DC converter 31 continues to operate. At the same time, as the first cut off switch element QS1 is turned off, the second input capacitor C2 cannot supply the power to the second DC-DC converter 32, and only the power to the first power output terminal 33 is supplied from the second input capacitor C2. Hence, the voltage of the second input capacitor C2 does not drop immediately, and the low side sustain switch element Q8Y continues to operate for a short while.

After a specified time, the voltage of the second input capacitor C2 becomes zero. That is, the potential of the first power output terminal 33 becomes zero. At this time, even if the control signal SG1 from the controller 30 is “L”, the gate potential of the low side sustain switch element Q8Y and the source potential of low side sustain switch element Q8Y are equal to each other, and the low side sustain switch element Q8Y which is a normally-on switch element continues to be in ON state.

As described above, in the switch elements connected in series, normally-on switch element and normally-off switch element are used in combination, and the normally-off switch element is immediately turned off in the event of power down due to fault. Hence even if a normally-on switch element is used, simultaneous short-circuiting of switch elements in the event of power down can be prevented. In this constitution, therefore, the normally-on switch element which is excellent in characteristics in switch element can be used.

Instead of the sustain switch element, either one of two recovery switch elements Q9Y and Q10Y may be composed of a normally-on switch element, and the other may be composed of a normally-off switch element. Or at least the separate switch element QS may be composed of a normally-on switch element. That is, at least one of two sustain switch elements, two recovery switch elements, and a separate switch element should be composed of a normally-on switch element.

This embodiment is applied to the scan electrode driving section, but the concept of the embodiment may be also applied to the sustain electrode driving section and the address electrode driving section.

1.5 Summary

In the PDP driving apparatus 10 in embodiment 1 of the invention, as mentioned above, when supply of external commercial alternating-current power source is stopped due to lightning strike or other fault, the gate voltage VG2 first becomes zero by the power source circuit, and then the gate voltage VG1 becomes zero. Therefore the high side sustain switch element (normally-off switch element) Q7Y is turned off, and then the low side sustain switch element (normally-on switch element) Q8Y is turned on, so that simultaneous short-circuiting can be prevented. Hence, although the PDP driving apparatus employs a normally-on type switch element, when the external commercial alternating-current power source is suddenly stopped, two sustain switch elements are not turned on simultaneously. That is, simultaneous short-circuiting is prevented, and the operation can be stopped safely without destroying the circuit. Hence, the PDP driving apparatus 10 of the embodiment becomes high in reliability.

### Embodiment 2

The plasma display in embodiment 2 of the invention has exactly the same configuration as the plasma display (FIG. 1) in embodiment 1. Hence, the detail of the configuration is same as explained in embodiment 1.

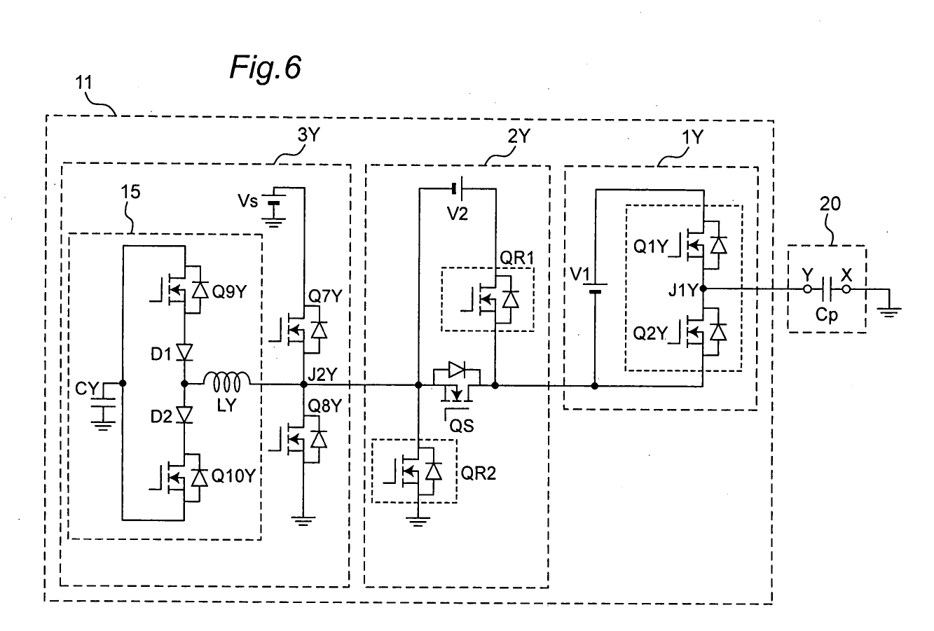

FIG. 6 shows an equivalent circuit diagram of the scan electrode driving section 11 and the PDP 20 in embodiment 2. The scan electrode driving section 11 of this embodiment is different from that of embodiment 1 (see FIG. 2) in that the high side sustain switch element Q7Y is a normally-on switch element and the low side sustain switch element Q8Y is a normally-off switch element. Other constituent elements of the embodiment are same as those in embodiment 1, and hence the explanation is omitted.

The equivalent circuit of the PDP 20 is, same as in FIG. 2, expressed only as a panel capacity Cp of the PDP 20, and the path of current flowing in the PDP 20 during the discharge in the discharge cell is omitted. Also the sustain electrode driving section connected to the sustain electrode X is omitted, and it is shown in grounded state in the diagram.

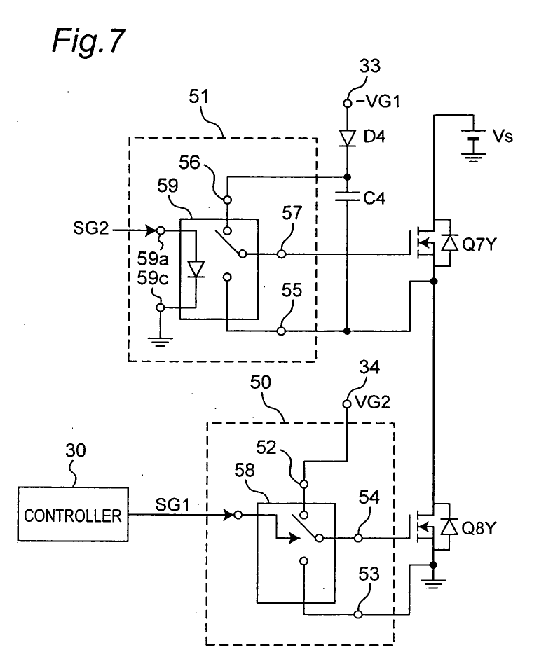

FIG. 7 is a circuit diagram of a gate driving circuit of the embodiment. The gate driving circuit of the embodiment is different from that in embodiment 1 in that a third gate signal circuit 50 is used instead of the first gate signal circuit 40 and a fourth gate signal circuit 51 is used instead of the second gate signal circuit 41. Other constituent elements of the embodiment are same as those in embodiment 1. In FIG. 7, the same reference signs as FIG. 5 area used to the same or like constituent elements.

FIG. 7 is a diagram of the gate driving circuit for the high side sustain switch element Q7Y and low side sustain switch element Q8Y of the embodiment.

A gate driving circuit for the high side recovery switch element Q9Y and low side recovery switch element Q10Y is nearly same as the gate driving circuit of the high side sustain switch element Q7Y, and thus the explanation is omitted.

In the gate driving circuit shown in FIG. 7, a voltage for driving the sustain switch elements Q7Y and Q8Y is supplied from the power source circuit shown in FIG. 4, through the first and second power output terminals 33 and 34.

The gate driving circuit shown in FIG. 7 includes a third gate signal circuit 50, a fourth gate signal circuit 51, a second driving capacitor C4, and a second driving diode D4.

The third gate signal circuit 50 receives a control signal SG1 for controlling the low side sustain switch element Q8Y from the controller 30. In the third gate signal circuit 50, a terminal 52 for supplying a voltage for turning on the switch element is connected to the second power output terminal 34. In the third gate signal circuit 50, a terminal 53 for supplying a voltage for turning off the switch element is connected to the source of the low side sustain switch element Q8Y. The output 54 of the third gate signal circuit 50 is connected to the gate of the low side sustain switch element Q8Y.

The fourth gate signal 51 incorporates a photo coupler 59, and the signal SG2 for controlling the high side sustain switch element Q7Y from the controller 30 is connected to the anode 59a of the photo coupler, and the cathode 59b of the photo coupler is grounded. In the fourth gate signal circuit 51, a terminal 55 for supplying a voltage for turning on the switch element is connected to the source of the high side sustain switch element Q7Y. In the fourth gate signal circuit 51, a terminal 56 for supplying a voltage for turning off the switch element is connected to the negative electrode of the second driving capacitor C4. The positive electrode of the second driving capacitor C4 is connected to the source of the high side sustain switch element Q7Y. The anode of the second driving diode D4 is connected to the first power output terminal 33, and the cathode of the second driving diode D4 is connected to the negative electrode of the second driving capacitor C4. The output 57 of the fourth gate signal circuit 51 is connected to the gate of the high side sustain switch element Q7Y. In this embodiment, the gate signal circuit incorporates a photo coupler, but the photo coupler may not be necessarily incorporated in the gate signal circuit. In such a case, for example, a photo coupler and a gate signal circuit are provided separately.

(Operation in Normal State)

The gate driving circuit normally operates as follows.

When the control signal SG1 from the controller 30 for controlling the low side sustain switch element Q8Y becomes “H”, the third gate signal circuit 50 applies a voltage higher than the source potential of the low side sustain switch element Q8Y by the voltage applied to the second power output terminal 34, to the gate of the low side sustain switch element Q8Y to turn on the low side sustain switch element Q8Y. At this time, the source potential of the high side sustain switch element Q7Y is at the grounding potential, and a voltage supplied from the first power output terminal 33 charges the second driving capacitor C4 by way of the second driving diode D4.

When the control signal SG1 becomes “L”, the third gate signal circuit 50 applies the source potential of the low side sustain switch element Q8Y to the gate of the low side sustain switch element Q8Y, and hence the low side sustain switch element Q8Y is turned off.

When the control signal SG2 for controlling the high side sustain switch element Q7Y becomes “H”, the fourth gate signal circuit 51 applies the source potential of the high side sustain switch element Q7Y to the gate of the high side sustain switch element Q7Y. The high side sustain switch element Q7Y is a normally-on switch element and is hence turned on.

When the control signal SG2 becomes “L”, the fourth gate signal circuit 51 applies a voltage lower than the source potential of the high side sustain switch element Q7Y by the voltage applied to the second driving capacitor C4, to the gate of the high side sustain switch element Q7Y, and hence the high side sustain switch element Q7Y is turned off.

Thus, the gate driving circuit of the embodiment amplifies a signal, and applies it to the gates of two sustain switch elements Q7Y and Q8Y to drive them.

(Operation During Power Down Due to Fault)

In the event of down of external commercial alternating-current power source due to lightning strike or other fault, the operation is as follows.

In the power source circuit shown in FIG. 4, when detecting stop of alternating-current voltage supply, the AC power detector 35 immediately turns off the first cut off switch QS1. As a result, the power supplied from the second input capacitor C2 is stepped, and the second DC-DC converter 32 immediately stops the operation to stop the supply of the second gate voltage VG2. Therefore, even if the control signal SG1 from the controller 30 is “H”, the potential of the second power output terminal 34 is neatly same as the source potential of the low side sustain switch element Q8Y, and hence the low side sustain switch element Q8Y does not turn on. Thus, the low side sustain switch element Q8Y can be turned off in a short time.

At this time, in the high side sustain switch element Q7Y, although the AC voltage is stopped, the first input capacitor C1 is still in charged state, and the first DC-DC converter 31 continues to operate. At the same time, the first cut off switch element QS1 is turned off, and the second input capacitor C2 cannot supply the power to the second DC-DC converter 32. The power is supplied only to the first power output terminal 33 from the second input capacitor C2. Hence, the voltage of the second input capacitor C2 does not drop suddenly. When the low side sustain switch element Q8Y is turned on, charging operation of the second driving capacitor C4 is conducted via the second driving diode D4. Therefore, the high side sustain switch element Q7Y continues to operate for a short while.

Charging operation of the second driving capacitor C4 is terminated when the low side sustain switch element Q8Y is completely turned off. Until the low side sustain switch element Q8Y is completely turned off, a voltage is maintained in the second driving capacitor C4.

After a specified time, the voltage of the second input capacitor C2 becomes zero. At this time, even if the control signal SG2 from the controller 30 for controlling the high side sustain switch element Q7Y is “L”, the fourth gate signal circuit 51 is always applying the source potential of the high side sustain switch element Q7Y to the gate of high side sustain switch element Q7Y. Thus the high side sustain switch element Q7Y which is a normally-on switch element continues to be in ON state.

In this constitution, too, in the event of power down due to fault, by immediately turning off the normally-off switch element, simultaneous short-circuiting of switch elements can be prevented. Therefore, the normally-on switch element which is excellent in characteristics can be used as switch element.

In the PDP driving apparatus 10 in embodiment 2 of the invention, as mentioned above, when supply of external commercial alternating-current power source is stopped due to lightning strike or other fault, the gate voltage VG2 first becomes zero by the power source circuit, and then the gate voltage VG1 becomes zero. Therefore the low side sustain switch element (normally-off switch element) Q8Y is turned off, and then the high side sustain switch element (normally-on switch element) Q7Y is turned on, so that simultaneous short-circuiting can be prevented. Hence, according to the PDP driving apparatus of the embodiment, although the PDP driving apparatus employs a normally-on type switch element, when the external commercial alternating-current power source is suddenly stopped, two sustain switch elements are not turned on simultaneously. That is, simultaneous short-circuiting is prevented, and the operation can be stopped safely without destroying the circuit. Hence, the PDP driving apparatus 10 of the embodiment becomes high in reliability.

### Embodiment 3

Embodiment 3 of the invention shows other configuration of the power source circuit.

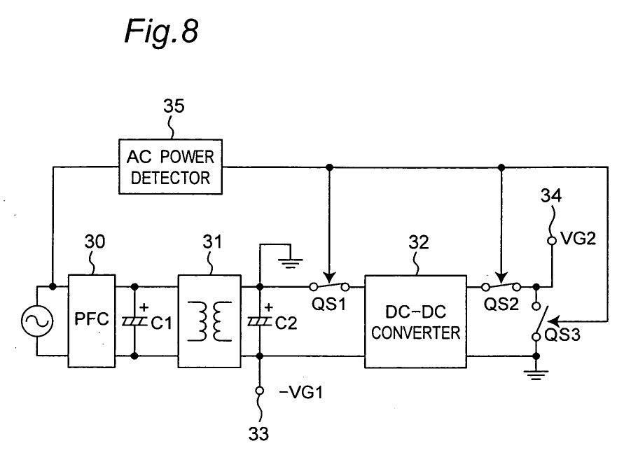

FIG. 8 shows a configuration of the power source circuit in this embodiment. The power source circuit in the embodiment is different from that in embodiment 1 in including a second cut off switch element QS2 and a short switch element QS3. Other constituent elements in the embodiment are same as constituent elements in embodiment 1.

As shown in FIG. 8, the power source circuit includes a power factor correction circuit 30, a first DC-DC DC converter 31, a second DC-DC converter 32, a first input capacitor C1, a second input capacitor C2, a first cut off switch QS1, an alternating-current (AC) power detector 35, a second cut off switch element QS2, and a short switch element QS3.

One end of the second cut off switch element QS2 is connected to the positive pole of the second gate voltage VG2, and the other end is connected to the second power output terminal 34. One end of the short switch element QS3 is connected to the second power output terminal 34, and the other end is connected to the negative pole of the second gate voltage VG2.

During ON period of the second cut off switch element QS2, the power is supplied to the gate driving circuit from the second DC-DC converter 32, and the operation of the second DC-DC converter 32 introduces output of the second gate voltage VG2. During OFF period of the second cut off switch element QS2, the power is not supplied to the gate driving circuit from the second DC-DC converter 32.

The second cut off switch element QS2 is controlled to be turned on or off by the AC power detector 35. The AC power detector 35 detects AC voltage or AC current of the external commercial alternating-current power source. When not detecting AC voltage nor AC current, the AC power detector 35 outputs a signal for turning off the second cut off switch element QS2. While detecting AC voltage or AC current, the AC power detector 35 outputs a signal for turning on the second cut off switch element QS2.

During OFF period of the short switch element QS3, since a voltage higher than the potential of the negative pole of the second gate voltage VG2 by a specified voltage is supplied from the second power output terminal 34, the power is supplied to the gate driving circuit. During ON period of the short switch element QS3, since a voltage almost same as the potential of negative pole of the second gate voltage VG is supplied from the second power output terminal 34, the power is not supplied from the second DC-DC converter 32 to the gate driving circuit.

The short switch element QS3 is controlled to be turned on or off by the AC power detector 35. The AC power detector 35 detects AC voltage or AC current of the external commercial alternating-current power source. When not detecting AC voltage or AC current, the AC power detector 35a outputs a signal for turning on the short switch element QS3. While detecting AC voltage or AC current, the AC power detector 35a outputs a signal for turning off the short switch element QS3.

In the PDP driving apparatus 10 of embodiment 3 of the invention, as mentioned above, even when supply of the external commercial alternating-current power source is stopped suddenly, supply of the gate voltage VG2 to the gate driving circuit can be stopped in a short time by the short switch element QS3 and the second cut off switch element QS2. Therefore, in the PDP driving apparatus 10 of the embodiment, in spite of employing a normally-on type switch element in the PDP driving apparatus, even if supply of the external commercial alternating-current power source is suddenly stopped, two sustain switch elements are not turned on simultaneously, that is, simultaneous short-circuiting is prevented, and the operation can be stopped safely without destroying the circuit. Hence, the PDP driving apparatus 10 of the embodiment has high reliability.

### INDUSTRIAL APPLICABILITY

The invention can be applied to a driving apparatus of a plasma display. In particular, the invention enables usage of normally-on switch element and can stop the circuit safely in the event of sudden power down of the commercial alternating-current power source. It is hence useful in the driving apparatus of the plasma display with a high reliability demanded.

Although the present invention has been described in connection with specified embodiments thereof, many other modifications, corrections and applications are apparent to those skilled in the art. Therefore, the present invention is not limited by the disclosure provided herein but limited only to the scope of the appended claims.

1. A PDP driving apparatus for driving a plasma display panel having sustain electrodes, scan electrodes, and address electrodes, comprising:
a plurality of switch elements,
wherein at least one of the plurality of switch elements is a normally-on switch element which turns on while a driving voltage is not applied to itself.

2. The PDP driving apparatus according to claim 1, further comprising a high side switch element and a low side switch element which is electrically coupled to the high side switch element in series,
wherein a specified pulse voltage is applied from a junction of the high side switch element and low side switch element to at least one of electrode of the scan electrode, the sustain electrode, and the address electrode of the plasma display panel, and
one of the high side switch element and low side switch element is a normally-on switch element which turns on while a driving voltage is not applied to itself, and the other is a normally-off switch element which turns off while a driving voltage is not applied to itself.

3. The PDP driving apparatus according to claim 1, further comprising:
a sustain voltage source that supplies a voltage which is to be applied during a sustain period for sustaining discharge of the plasma display panel, and
a separate switch element capable of cutting off one of a current flowing to a positive electrode of the sustain voltage source and a current flowing from a negative electrode of the sustain voltage source,
wherein the separate switch element is a normally-on switch element.

4. The PDP driving apparatus according to claim 1, further comprising:
an inductor electrically coupled to at least one of the scan electrode, the sustain electrode and the address electrode, and
a plurality of recovery switch elements that form during ON period a path through which a resonance current due to the inductor and the plasma display panel flows,
wherein at least one of the plural recovery switch elements is a normally-on switch element.

5. The PDP driving apparatus according to claim 1, wherein the normally-on switch element is a wide band gap semiconductor switch element.

6. The PDP driving apparatus according to claim 5, wherein the wide band gap semiconductor switch element is formed of material including at least one of SiC, diamond, GaN, and ZnO.

7. The PDP driving apparatus according to claim 1, wherein the normally-on switch element is either one of MOSFET, JFET, MESFET, IGBT, and bipolar transistor.

8. The PDP driving apparatus according to claim 1, further comprising:
a first DC-DC converter that generates a voltage of negative polarity; and
a second DC-DC converter that receives the output voltage from the first DC-DC converter as input voltage to generate a voltage of positive polarity;
wherein when supply of a voltage from an external commercial alternating-current is stopped, the second DC-DC converter is stopped, and then the first DC-DC converter is stopped.

9. The PDP driving apparatus according to claim 8, further comprising a first cut off switch element that switches supply or stop of an output voltage from the first DC-DC converter to the second DC-DC converter,
wherein when supply of a voltage from an external commercial alternating-current is stopped, the first cut off switch element cuts off the supply of the output voltage from the first DC-DC converter to the second DC-DC converter.

10. The PDP driving apparatus according to claim 8, further comprising a second cut off switch element that switches supply or stop of an output voltage of the second DC-DC converter,
wherein when supply of a voltage from an external commercial alternating-current is stopped, the second cut off switch element cuts off the supply of the output voltage of the second DC-DC converter.

11. The PDP driving apparatus according to claim 8, further comprising a short switch element that shorts the output voltage of the second DC-DC converter,
wherein when supply of a voltage from an external commercial alternating-current is stopped, the short switch element shorts the output voltage of the second DC-DC converter.

12. The PDP driving apparatus according to claim 2, further comprising:
a section that supplies a driving voltage to one switch element which is a normally-on switch element to maintain the one switch element in ON state until the other switch element which is a normally-off switch element reaches OFF state, when supply of a voltage from an external commercial alternating-current is stopped.

13. A plasma display, comprising:
a plasma display panel having sustain electrodes, scan electrodes, and address electrodes; and
a PDP driving apparatus according to claim 1 that drives the plasma display panel.

14. The plasma display according to claim 13, wherein
the PDP driving apparatus further comprises a high side switch element and a low side switch element which is electrically coupled to the high side switch element in series,
a specified pulse voltage is applied from a junction of the high side switch element and low side switch element to at least one of electrode of the scan electrode, the sustain electrode, and the address electrode of the plasma display panel, and
one of the high side switch element and low side switch element is a normally-on switch element which turns on while a driving voltage is not applied to itself, and the other is a normally-off switch element which turns off while a driving voltage is not applied to itself.

15. The plasma display according to claim 13, wherein,
the PDP driving apparatus further comprises a sustain voltage source that supplies a voltage which is to be applied during a sustain period for sustaining discharge of the plasma display panel, and a separate switch element capable of cutting off one of a current flowing to a positive electrode of the sustain voltage source and a current flowing from a negative electrode of the sustain voltage source, and
the separate switch element is a normally-on switch element.

16. The plasma display according to claim 13, wherein,
the PDP driving apparatus further comprises an inductor electrically coupled to at least one of the scan electrode, the sustain electrode and the address electrode, and a plurality of recovery switch elements that form during ON period a path through which a resonance current due to the inductor and the plasma display panel flows, and
at least one of the plural recovery switch elements is a normally-on switch element.

17. The plasma display according to claim 13, wherein the normally-on switch element is a wide band gap semiconductor switch element.

18. The plasma display according to claim 17, wherein the wide band gap semiconductor switch element is formed of material including at least one of SiC, diamond, GaN, and ZnO.

19. The plasma display according to claim 13, wherein the normally-on switch element is either one of MOSFET, JFET, MESFET, IGBT, and bipolar transistor.

20. The plasma display according to claim 13, wherein
the PDP driving apparatus further comprises
a first DC-DC converter that generates a voltage of negative polarity, and
a second DC-DC converter that receives the output voltage from the first DC-DC converter as input voltage to generate a voltage of positive polarity, and
when supply of a voltage from an external commercial alternating-current is stopped, the second DC-DC converter is stopped, and then the first DC-DC converter is stopped.

21. The plasma display according to claim 20, wherein the PDP driving apparatus further comprises a first cut off switch element that switches supply or stop of an output voltage from the first DC-DC converter to the second DC-DC converter, and
when supply of a voltage from an external commercial alternating-current is stopped, the first cut off switch element cuts off the supply of the output voltage from the first DC-DC converter to the second DC-DC converter.

22. The plasma display according to claim 20, wherein
the PDP driving apparatus further comprises a second cut off switch element that switches supply or stop of an output voltage of the second DC-DC converter, and
when supply of a voltage from an external commercial alternating-current is stopped, the second cut off switch element cuts off the supply of the output voltage of the second DC-DC converter.

23. The plasma display according to claim 20, wherein
the PDP driving apparatus further comprises a short switch element that shorts the output voltage of the second DC-DC converter, and
when supply of a voltage from an external commercial alternating-current is stopped, the short switch element shorts the output voltage of the second DC-DC converter.

24. The plasma display according to claim 14, wherein
the PDP driving apparatus further comprises a section that supplies a driving voltage to one switch element which is a normally-on switch element to maintain the one switch element is ON state until the other switch element which is a normally-off switch element reaches OFF state, when supply of a voltage from an external commercial alternating-current is stopped.
